(19) United States
(12) Patent Application Publication
(10) Pub. No.: US 2020/0198459 A1
(43) Pub. Date: Jun. 25, 2020

(54) LIQUID CONTAINER FOR A MOTOR VEHICLE AND METHOD FOR MANUFACTURING A LIQUID CONTAINER

(71) Applicant: KAUTEX TEXTRON GMBH & CO. KG, Bonn (DE)

(72) Inventors: Roman BOUFFIER, Koenigswinter (DE); Hartmut WOLF, Koenigswinter (DE); Christian KOPIEC, Troisdorf (DE); Klaus GEBERT, Willich (DE); Sebastian Stefan ROSENSTRAETER, Koeln (DE); Fabian SIGGIA, Koeln (DE); Markus HUETZEN, Sankt Augustin (DE)

(21) Appl. No.: 16/642,672

(22) PCT Filed: Aug. 24, 2018
(86) PCT No.: PCT/EP2018/072929

§ 371 Date: Feb. 27, 2020

(30) Foreign Application Priority Data
Aug. 28, 2017 (DE) 10 2017 119 708.7

(51) Int. Cl. B60K 15/03

(52) U.S. Cl. CPC B60K 15/03177; B60K 2015/03046; B29D 22/003; B60K 2015/03493; B60K 2015/03059

(57) ABSTRACT

A liquid container for a motor vehicle, having a first half-shell and a second half-shell, the half-shells delimiting a storage volume for accommodating liquid, the first half-shell having a first support layerand a first barrier layer, the second half-shell having a second support layerand a second barrier layer, the first barrier being situated on a side of the first support layer facing the storage volume, and the second barrier layer being situated on a side of the second support layer facing the storage volume.

### FIELD

The present invention relates to a liquid container for a motor vehicle and a method for manufacturing a liquid container.

### BACKGROUND

Recent motor vehicles contain numerous operating fluids such as fuel, urea solution for exhaust aftertreatment, and coolant. The liquids are accommodated in a respective liquid container. For example, plastic fuel containers are used for storing fuel.

Such plastic fuel containers should ideally be lightweight, crash-proof, and low in emissions. With regard to emissions, the increasingly stringent maximum allowable regulatory emission limits for evaporation of hydrocarbons from fuel into the environment must be observed. This requires the avoidance of fuel leaks under all operating conditions, for example during refueling, including refueling venting, during operational venting, i.e., the offgassing of fuel when the temperature of a tank system increases, and the diffusion of hydrocarbons through the container wall.

Known fuel containers have a diffusion barrier to keep the diffusion through the container wall low. If such a fuel container is formed by putting together two injection-molded half-shells, for example for each half-shell an interior barrier layer may be situated on a support material. It is disadvantageous that connecting elements or molded elements of the support material, possibly integrated during the injection molding and protruding into the storage volume, penetrate the barrier layer and thus form permeation paths, resulting in increased fuel emissions.

### SUMMARY

Against this background, the technical object of the invention is to provide a liquid container and a method for manufacturing a liquid container which do not have, at least to an appreciable extent, the disadvantages described above, and which in particular allow reduced diffusion-related emissions from a liquid container.

According to a first aspect, the invention relates to a liquid container for a motor vehicle, having a first half-shell and a second half-shell, the half-shells delimiting a storage volume for accommodating liquids, the first half-shell having a first support layer and a first barrier layer, the second half-shell having a second support layer and a second barrier layer, the first barrier being situated on a side of the first support layer facing away from the storage volume, and the second barrier layer being situated on a side of the second support layer facing the storage volume.

The first half-shell may be an upper shell of a plastic fuel container for a motor vehicle. The second half-shell may be a lower shell of the plastic fuel container.

The upper shell in the installed state faces the vehicle. The lower shell in the installed state faces away from the vehicle, i.e., faces the street or roadway. Accordingly, due to the interior arrangement of the second barrier layer, the second barrier layer is protected from mechanical abrasion, for example from road stones.

For the first barrier layer, which is situated on the exterior, such protection is not necessary due to the arrangement facing the vehicle. The upper shell may thus be used for attaching, in particular welding on, interior mounting parts or molded elements without penetrating the first barrier layer.

According to another embodiment of the liquid container, it is provided that the first support layer on a side facing the storage volume has one or more molded elements, connecting parts, or functional units. These may be, for example, valve holders, clips for form-fit and force-fit fastening of functional units, or pedestals for integrally joining functional units. As a result of the first barrier layer being situated on a side of the first support layer facing away from the storage volume, the molded elements, connecting parts, or functional units may be mounted, molded on, or applied on the side of the first support layer facing the storage volume without the first barrier layer being interrupted. Molded elements formed integrally or in one piece in an injection molding process, for example, may thus be manufactured without adversely affecting the structural integrity of the first barrier layer.

The molded elements, connecting parts, or functional units may be, for example, elements that extend with protrusion into the storage volume.

The molded elements and/or connecting parts may have been formed in one piece with the first support layer in an injection molding process and/or sequentially molded onto the first support layer. The integral joining of the molded elements and/or connecting parts, carried out in one piece in the injection molding process, has the advantage that it is possible to cost-effectively manufacture the molded elements and/or connecting parts. The sequential molding on of the molded elements and/or connecting parts offers the advantage of greater freedom of design with regard to the wall thickness and position of the molded elements and/or connecting parts.

According to another embodiment of the liquid container, it is provided that all molded elements, connecting parts, or functional units situated in the storage volume are provided on the first support layer, with no molded elements, connecting parts, or functional units situated in the storage volume being provided on the second barrier layer. In this way, all necessary molded elements, connecting parts, or functional units may be situated within the liquid container without the need for penetrating or interrupting the first barrier layer or the second barrier layer.

Alternatively, it may be provided that a plastic that is used for attaching one or more molded elements, connecting parts, or functional units is locally molded onto a side of the second barrier layer facing away from the second support layer. For example, after the support layer is produced by injection molding, a support material may be locally molded onto the second barrier layer, on a side of the barrier layer facing away from the support layer, by sequential injection molding. The locally molded-on plastic may be a pedestal or a plate-like element, for example, made of the support material, to which, for example, a surge tank may be welded or adhesively bonded. In this way, a functional unit may be situated in the area of the second half-shell having an interior barrier layer, without penetrating or interrupting the second barrier layer. The barrier effect of the second barrier layer may thus be maintained, and in addition molded elements, connecting parts, or functional units may be situated in the area of the locally molded-on plastic of the lower half-shell.

At least one of the barrier layers may be a one-ply film that has been integrally joined to the associated support layer in an injection molding process. For this purpose, the film may be accommodated in a mold half of an injection mold and molded on or back-molded with plasticized support material. An integral bond is formed between the barrier film and the support layer via the injection molding process. A half-shell having a support layer and a barrier film may thus be cost-effectively manufactured with low usage of material.

Alternatively or additionally, it may be provided that at least one of the barrier layers is a multi-ply film that has been integrally joined to the associated support layer in an injection molding process. Such a multi-ply film may be a five-ply film, for example, that contains a central layer made of ethylene vinyl alcohol copolymer (EVOH), and the EVOH layer is covered on both sides by a low-density polyethylene (LDPE) layer, and the LDPE layers are covered by high-density polyethylene (HDPE) layers.

The cover layers of a multi-ply film may in particular have the same design as the support material in order to achieve a reliable integral bond between the support material and the barrier film. The barrier effect of a multilayer film may thus be provided primarily by an EVOH layer, for example, while the LDPE layers are each used as an adhesion promoter for the exterior HDPE layers, and the HDPE layers may in turn may be provided with a support material for reliable adhesion or an integral bond, wherein the support material may likewise be made of the HDPE of the cover layers of the barrier film.

The liquid container may be a plastic fuel container for accommodating gasoline or diesel fuel. The barrier layers and/or support layers are in particular suited for being in contact with diesel fuel or gasoline. The material of the barrier layer and the material of the support layer, with regard to their swelling properties, must therefore be suitable for being in direct contact with a liquid fuel. The support material as well as the barrier layer, with regard to their chemical resistance and swelling properties, must be suitable for use in direct contact with fuel.

The one-ply or multi-ply support layer may contain one or more of the following materials or may be made of one or more of the following materials: elastomer, thermoplastic elastomer, high-density polyethylene (HDPE), fiber-reinforced polyamide, polyamide (PA), partially aromatic polyamide, impact-resistant polyamide.

The one-ply or multi-ply barrier layer may contain one or more of the following materials or may be made of one or more of the following materials: ethylene vinyl alcohol copolymer (EVOH), low-density polyethylene (LDPE), polyether ether ketone (PEEK), polyamide (PA), partially aromatic polyamide, high-density polyethylene (HDPE), fluoropolymer. For example, the barrier layer may have a three-ply design made of PA and EVOH, with a central EVOH ply being covered or bordered on both sides by a PA cover layer. It is also possible, for example, to provide a six-ply wall structure or the above-described five-ply structure made of HDPE, LDPE, and EVOH.

According to another embodiment of the liquid container, it is provided that the half-shells in a connecting area are integrally joined together, wherein the first support layer in the connecting area is integrally joined to the second barrier layer and/or to the second support layer, and the first barrier layer and the second barrier layer in the connecting area are spaced apart from one another and border the first support layer on both sides, wherein the first support layer in the connecting area forms a permeation path between the storage volume and the surroundings of the liquid container.

The integral joining of the half-shells to form a closed liquid container may take place by means of a plastic welding method, in particular noncontactless methods or contactless welding methods. Examples include hot plate welding, vibration welding, radiation welding, ultrasonic welding, or hot gas welding.

If the barrier layers in the connecting area are spaced apart from one another and a permeation path is formed from support material of the support layer, the two barrier layers therefore do not form a closed barrier bladder, which would surround the storage volume essentially completely, i.e., except for mandatory tank connections; instead, in the connecting area a section made of the first support material is present, via which there is a connection between the storage volume and the surroundings, which has effective diffusion and is not delimited by the barrier films.

To keep the diffusion-related emissions along the permeation path low, it may be provided that a length of the permeation path, viewed in a cross section, is greater than or equal to twice the width of the permeation path, wherein the width of the permeation path corresponds to the distance between the barrier layers in the connecting area. In other words, such a permeation path in the connecting area should have a preferably extended, narrow design in order to minimize the diffusion-related emissions.

Alternatively or additionally, it may be further provided that a length of the permeation path, viewed in a cross section, is greater than a wall thickness of the first half-shell and of the second half-shell.

Such a configuration may be achieved, for example, by the permeation path extending at an angle with respect to a horizontal plane, viewed in the installation position of the liquid container. The permeation path or a connecting area that is formed between the half-shells may thus extend in an inclined or oblique manner in order to lengthen the permeation path via the structural design without significantly increasing the dimensions of the liquid container.

It may be provided that the first barrier layer and the second barrier layer are integrally joined together. In this case, no permeation path is formed in a connecting area between the half-shells, and the barrier layers form an essentially closed barrier bladder which essentially completely surrounds the storage volume of the liquid container, with the limitation that the mandatory tank connections such as the filling neck, vent, and/or withdrawal opening are provided. Diffusion-related emissions may be reliably limited in this way.

When a reference is made herein that the barrier layers essentially completely surround the storage volume, this refers in particular to avoiding a permeation path in the connecting area between the half-shells, and it is understood that for filling the liquid container with fuel and for withdrawing the fuel from the liquid container, supply lines, outlets, and/or vent valves are provided, in whose vicinity the first or second barrier layer is locally penetrated. Accordingly, the wall of a half-shell may be provided with penetrating connection openings. The connection openings may have been produced in the injection molding process.

According to another embodiment of the liquid container, it is provided that the first barrier layer essentially completely covers the side of the first support layer facing the storage volume. Reliable encapsulation of a liquid fuel to be stored, for example, may be achieved in this way.

Alternatively or additionally, it may be provided that the second barrier layer essentially completely covers the side of the second support layer facing the storage volume. Once again, this serves to reliably reduce diffusion-related emissions.

The phrase “essentially completely” takes into account the above-discussed inlets and outlets optionally required for a tank system.

It may be provided that at least one of the half-shells of the liquid container has a web, wherein the web is seated in a form-fit manner in a receptacle of the respective other half-shell that has a complementary shape, at least in sections, wherein an integral bond of the half-shells is formed along the web. For example, the first half-shell may be provided with such a web, and the first half-shell in particular may form a cover for the second half-shell.

The first and second half-shells may have an asymmetrical design, with the second half-shell forming, for example, a shell that is open at the top which is closeable by the first half-shell.

The web together with a complementary shape may form centering, so that a reliable integral bond is achieved along the entire circumferentially extending joining area when the first and second half-shells are assembled. Accordingly, the first half-shell may form, for example, self-centering of the cover with regard to the second half-shell.

A freely projecting wall section of the second half-shell, which may be provided for accommodating the first half-shell, may have a circumferential mounting bevel, for example, that extends at an angle with respect to a horizontal plane in the installed state of the liquid container, in order to structurally design an extended permeation path without significantly increasing the component dimensions of the liquid container. The first half-shell may have a recess or fold that has a complementary shape to the bevel, and that may be formed by a circumferential weld collar or web on the first half-shell and centered on the second half-shell.

According to another embodiment of the liquid container, it is provided that the barrier layer of the half-shell that has the web is turned down around the web on the end or encloses the web, the barrier layer in particular at least partially covering an end-face side of the web. If the web is provided, for example, on the first half-shell having an exterior barrier layer, enclosure of the web, at least in sections, may locally narrow the width of a permeation path between the barrier layers in the area where the permeation path exits to the surroundings, in order to increase the barrier effect. Alternatively or additionally, it may be provided that the exterior barrier layer or barrier film of the first half-shell, which is turned down around the web on the end-face side, rests against the second barrier layer of the second half-shell and/or is integrally joined thereto. Once again, an essentially closed barrier bladder may thus be formed which essentially completely surrounds the storage volume circumferentially.

It may be provided that the web, at least in sections, is made of a laser-transparent plastic, the integral bond having been formed by laser transmission welding. A high-quality weld joint may be quickly achieved in this way.

The wall thickness of one of the support layers itself may be 2 mm to 6 mm, in particular 2 mm to 4 mm. This small wall thickness may be provided, for example, over 90% of the overall surface of a half-shell, wherein local reinforcing ribs, outlets, or other local thickened areas may be provided.

The thickness of one of the barrier layers, in particular barrier films, may be 100 μm to 1000 μm.

According to a second aspect, the invention relates to a method for manufacturing a liquid container, having the method steps:
injection molding of a first half-shell, the first half-shell having a first support layer and a first barrier layer,
injection molding of a second half-shell, the second half-shell having a second support layer and a second barrier layer,
joining the half-shells in such a way that the half-shells delimit a storage volume for accommodating liquid, the first barrier layer being situated on a side of the first support layer facing the storage volume, and the second barrier layer being situated on a side of the second support layer facing the storage volume.

As the result of combining a half-shell having an exterior barrier layer with a half-shell having an interior barrier layer, by use of the method according to the invention a liquid container may be provided that offers a high level of security against diffusion-related emissions, and at the same time allows the attachment of mounting parts within or inside the storage volume without penetrating the first barrier layer.

### BRIEF DESCRIPTION OF THE DRAWINGS

The invention is described in greater detail below with reference to the drawings, which schematically illustrate one exemplary embodiment, as follows:

FIG. 1 shows a liquid container according to the invention in a cross section;

FIG. 2 shows an enlarged detail from FIG. 1;

FIG. 3 shows another exemplary embodiment of a liquid container according to the invention in a cross section;

FIG. 4 shows another exemplary embodiment of a liquid container according to the invention in a cross section;

FIG. 5 shows another exemplary embodiment of a liquid container according to the invention in a cross section;

FIG. 6 shows another exemplary embodiment of a liquid container according to the invention in a cross section;

FIG. 7 shows another exemplary embodiment of a liquid container according to the invention in a cross section;

FIG. 8 shows another exemplary embodiment of a liquid container according to the invention in a cross section;

FIG. 9 shows another exemplary embodiment of a liquid container according to the invention in a cross section;

FIG. 10 shows another exemplary embodiment of a liquid container according to the invention in a cross section;

FIG. 11 shows another exemplary embodiment of a liquid container according to the invention in a cross section;

FIG. 12 shows another exemplary embodiment of a liquid container according to the invention in a cross section; and

FIG. 13 shows another exemplary embodiment of a liquid container according to the invention in a cross section.

### DETAILED DESCRIPTION

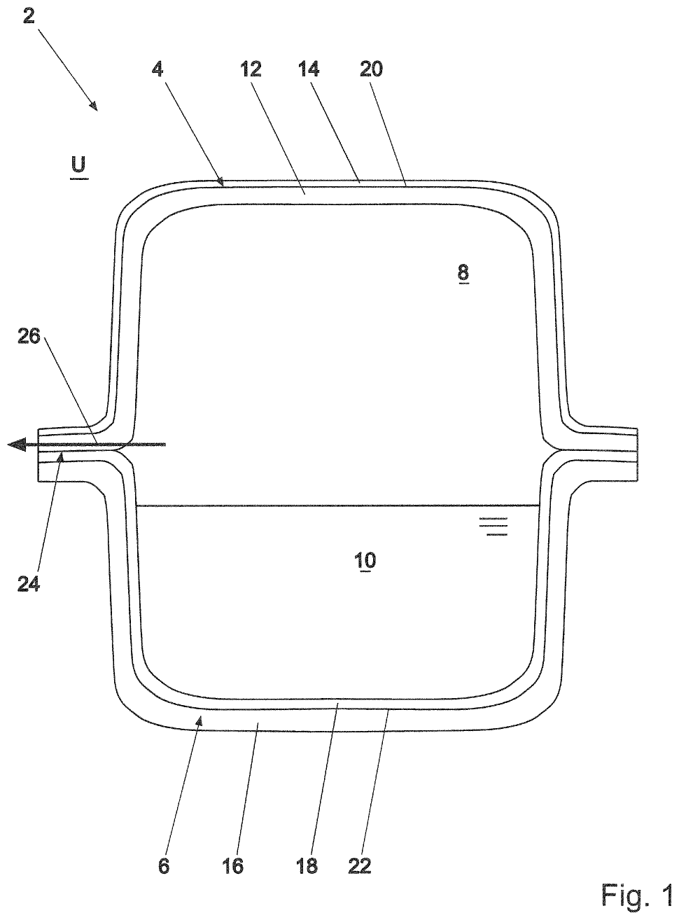

FIG. 1 shows a liquid container 2 for a motor vehicle in a cross section. The liquid container 2 is a plastic fuel container 2.

The liquid container 2 has a first half-shell 4 and a second half-shell 6. The half-shells 4, 6 delimit a storage volume 8 for accommodating liquid 10. In the present case the liquid 10 is fuel 10 for operating an internal combustion engine of a motor vehicle. The first half-shell 4 has a first support layer 12 and a first barrier layer 14. The second half-shell 6 has a second support layer 16 and a second barrier layer 18.

The first barrier layer 14 is situated on a side 20 of the first support layer 12 facing away from the storage volume 8. The second barrier layer 18 is situated on a side 22 of the second support layer 16 facing the storage volume 8. The first barrier layer 14 may therefore be referred to as an exterior barrier layer 14, while the barrier layer 18 may be referred to as an interior barrier layer 18.

In the example in FIG. 1, the first barrier layer 14 is a one-ply film that has been integrally joined to the support layer 12 in an injection molding process. In addition, the second support layer 16 has also been molded onto the second barrier layer 18 in an injection molding process in order to integrally join the second barrier layer 18 to the second support layer 16. In the present case, the second barrier layer 18 is also designed as a one-ply film.

It is understood that according to further exemplary embodiments of the invention, the first barrier layer may be made up of one layer, in particular a one-ply film, while the second barrier layer may be made up of multiple layers, in particular a multi-ply film, each of which has been joined to associated support layers in the injection molding process.

The half-shells 4, 6 are integrally joined together in a connecting area 24. The first support layer 12 is integrally joined to the second barrier layer 18 in the connecting area 24. The first barrier layer 14 and the second barrier layer 18 are spaced apart from one another in the connecting area 24, and border the first support layer 12 on both sides.

The first support layer 12 forms a permeation path 26 in the connecting area 24, between the storage volume 8 and the surroundings U of the liquid container 2. In other words, the first barrier layer 14 and the second barrier layer 18 in the connecting area 24 do not form a closed barrier bladder, which would essentially completely surround the storage volume 8, but instead delimit the permeation path 26 on both sides.

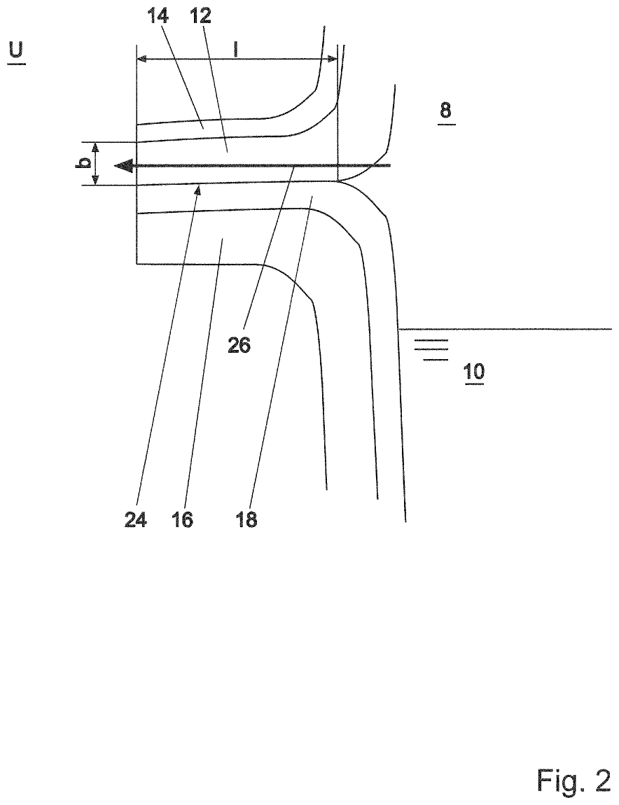

FIG. 2 shows an enlarged illustration of the connecting area 24 from FIG. 1. As is apparent from FIG. 2, a length 1 of the permeation path 26 is more than twice the width b of the permeation path 26. The width b of the permeation path 26 corresponds to the distance between the barrier layers 14, 18 in the connecting area 24. Thus, according to the first exemplary embodiment, diffusion-related emissions of the fuel 10 occur through the material of the first support layer 12 into the surroundings U via the permeation path 26.

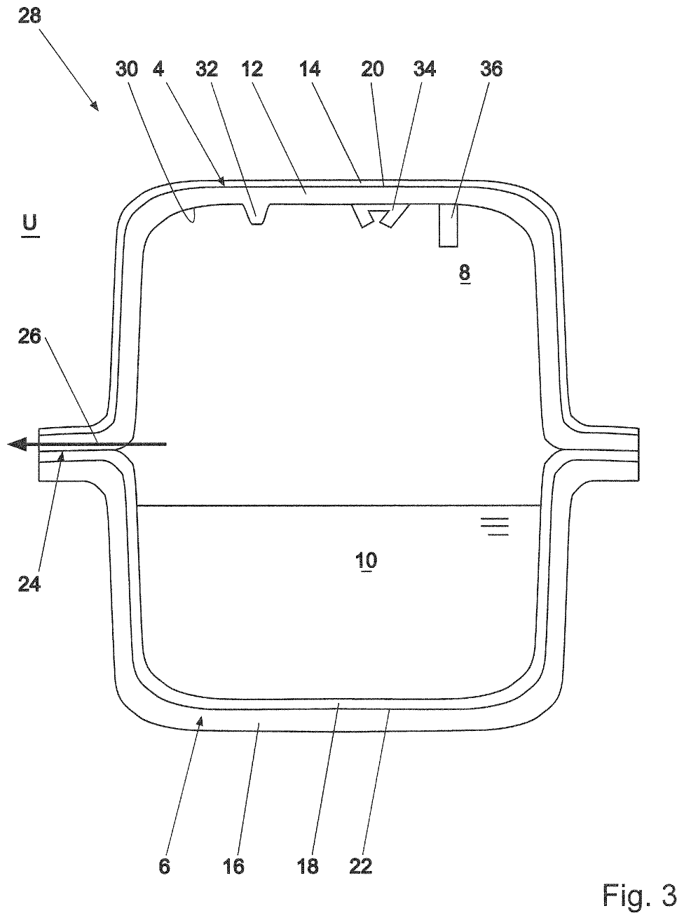

FIG. 3 shows another exemplary embodiment of a liquid container 28 according to the invention. The liquid container 28 is a plastic fuel container 28 for a motor vehicle. In the following description, identical features with reference to FIG. 2 are assigned the same reference numerals. Therefore, to avoid repetition, only the differences from the first exemplary embodiment are discussed.

The first support layer 12 of the liquid container 28 has a molded element 32, a connecting part 34, and a functional unit 36 on a side 30 facing the storage volume 8. The molded element 32 has been formed in one piece with the first support layer 12 in the injection molding process, and may be used to reinforce the structure. In the present case the connecting part 34 is a clip that may be used to fasten functional units inside the liquid container 28. The clip 34 has been subsequently integrally joined to the support layer 12 formed in the injection molding process. This similarly applies for the functional unit 36, which in the present case may be a pressure sensor or a filling level sensor, for example.

The molded element 32, the connecting parts 34, and the functional unit 36 extend with a protrusion into the storage volume 8. In the present example of the liquid container 28 according to FIG. 3, all molded elements 32, connecting parts 34, and functional units 36 situated in the storage volume, each of which is illustrated by way of example, are provided on the first support layer 12, with no molded elements, connecting parts, or functional units that are situated in the storage volume 8 being provided on the second barrier layer 18.

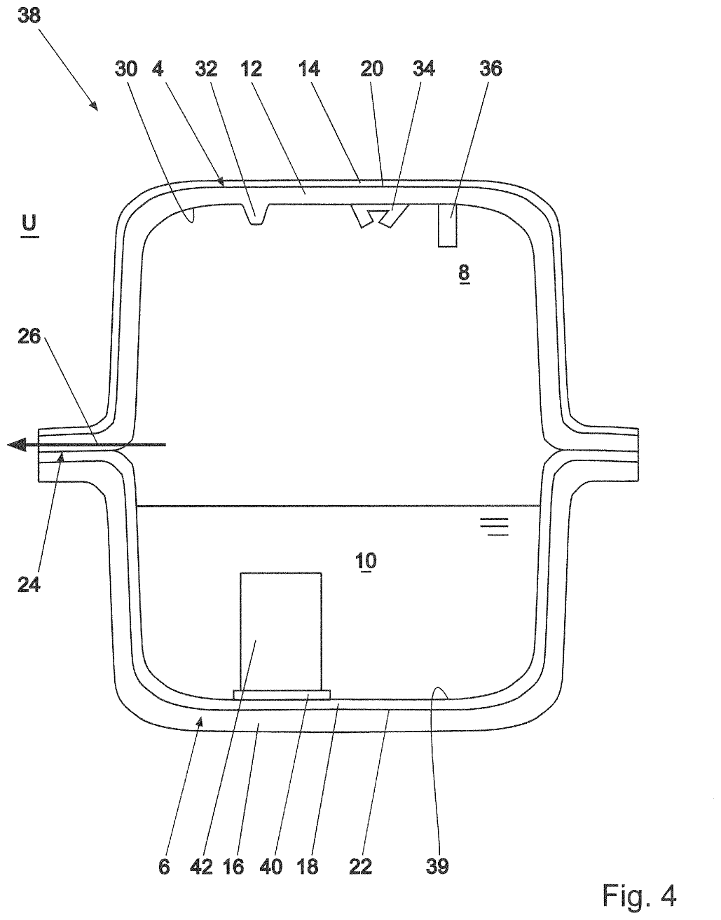

FIG. 4 shows another variant according to the invention of a liquid container 38. The liquid container 38 is a plastic fuel container 38 for a motor vehicle. To avoid repetition, once again only the differences in the exemplary embodiment according to FIG. 4 compared to the previously described exemplary embodiment according to FIG. 3 are discussed. Identical features are assigned the same reference numerals.

In contrast to the liquid container 28 from FIG. 3, for the liquid container 38 in FIG. 4 a plastic 40 that is used for attaching molded elements, connecting parts, or functional units is locally molded onto a side 39 of the second barrier layer 18 facing away from the second support layer 16.

The locally molded-on plastic 40 in the present case forms a pedestal 40 to which a surge tank 42 is welded.

The pedestal 40 has been produced by sequential injection molding. The barrier film 18 held in an injection mold has initially been integrally joined to the support layer 16. In a subsequent, second injection molding step the pedestal 40 has been molded onto the side 39 of the barrier layer 18 facing away from the support layer 16. In a further step the surge tank 42 has been integrally joined to the pedestal 40 by welding. It is thus possible for the surge tank 42 to be incorporated into the storage volume 8, with an interior barrier layer 18, without destroying the structural integrity of the barrier layer 18.

Further elements such as valves, Venturi nozzles, or the like may be provided on the pedestal or multiple separate pedestals or localized material moldings.

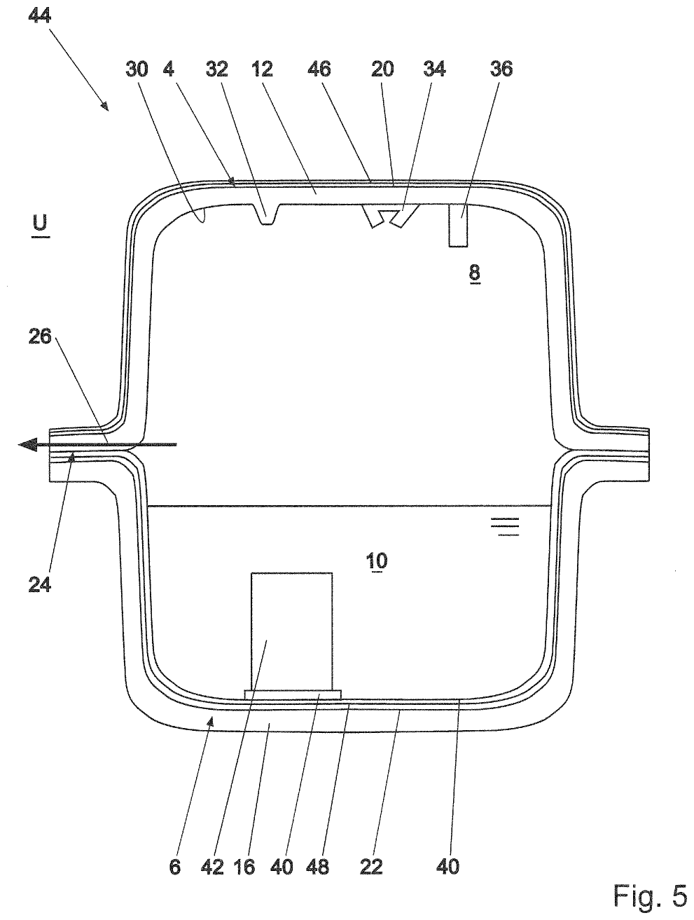

FIG. 5 shows another variant of a liquid container 44 according to the invention. The liquid container 44 is a plastic fuel container 44 for a motor vehicle. In contrast to the exemplary embodiments described above, a first barrier layer 46 and a second barrier layer 48 designed as multi-ply films 46, 48 are provided.

The first barrier layer 48 [sic; 46] has a central layer made of EVOH, which is covered on both sides by adhesion promoter layers made of LDPE. The LDPE adhesion promoter layers are in turn covered by cover layers made of HDPE. This five-ply, integrally joined film layer composite forms the first barrier layer 46. The first support layer 12 in the present case is likewise made of the HDPE of the cover layers of the first barrier layer, so that the first barrier layer 46 and the first support layer 12 have been integrally joined in the injection molding process, using the same materials. The second barrier layer 48 of the second half-shell 6 has an analogous design, and once again is internally situated on the second support layer 16.

It is understood that according to further exemplary embodiments of the invention, for example the first half-shell may be provided with a one-ply barrier layer or film, while the second half-shell may have a multi-ply or multilayer film as the barrier layer, or vice versa.

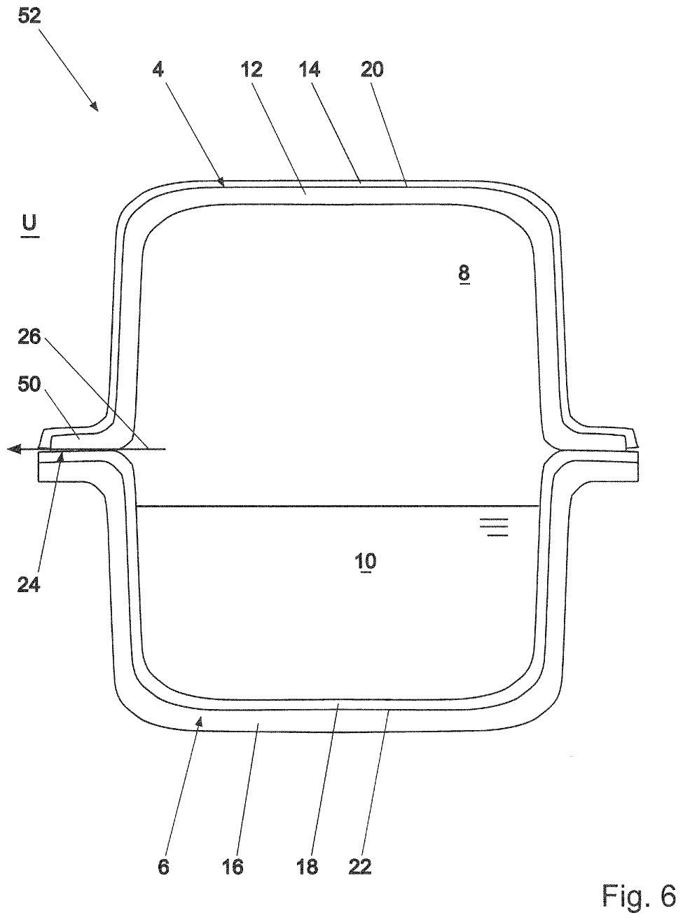

FIG. 6 shows another variant of a liquid container 52 according to the invention, in which the barrier layer 14 on the end-face side encloses, at least in sections, a web 50 that is formed on the support layer 12. The permeation path 26 of the liquid container 52 shown in FIG. 6 is thus narrowed on the end-face side due to being enclosed by the barrier layer 40 [sic; 14], in order to keep the diffusion-related emissions of fuel 10 into the surroundings U low.

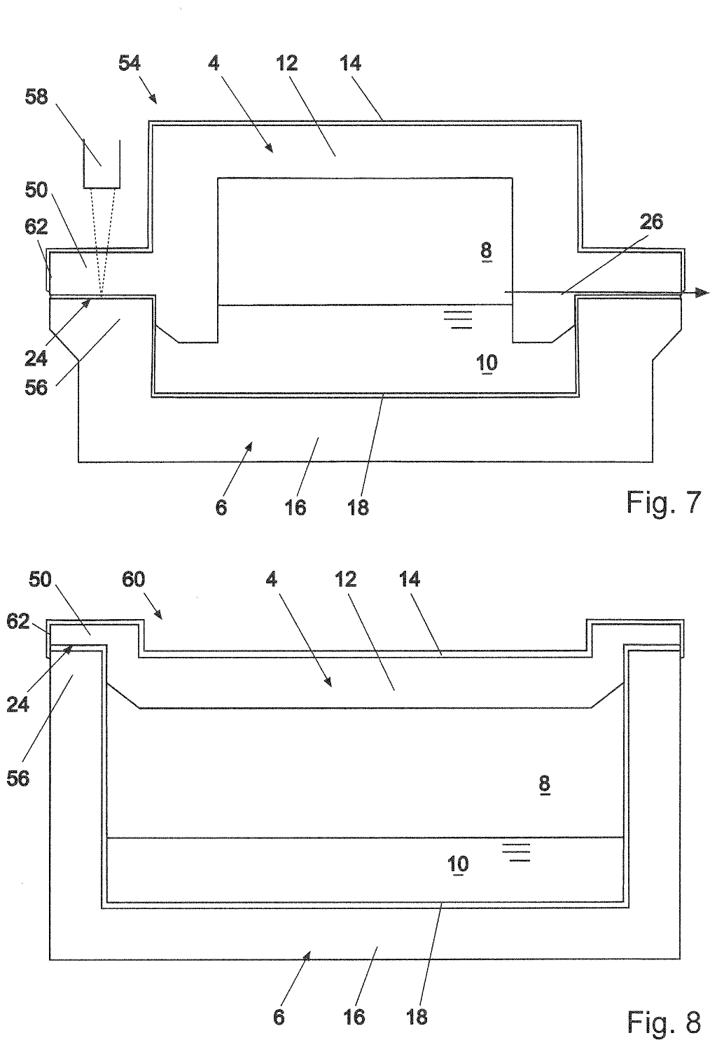

FIGS. 7 through 13 show further variants of liquid containers according to the invention, which differ in particular in the geometry of the connecting areas between the half-shells.

FIG. 7 shows a liquid container 54 whose first half-shell 4 has a web 50, the web 50 being seated in a form-fit manner in a receptacle 56 in the second half-shell 6 which has a complementary shape, at least in sections. According to the exemplary embodiment in FIG. 7, the first support layer 12 of the first half-shell 4 and the first barrier layer 14 of the first half-shell 4 are made of a laser-transparent plastic, so that the second barrier layer 18, which in the present case is made of a non-laser-transparent plastic, may be welded to the first support layer 12 by laser transmission welding with the aid of a laser 58.

FIG. 8 shows another variant of a liquid container 60 which differs from the variant in FIG. 7 in that the first barrier layer 14 overlaps the second barrier layer 18. The barrier layers 14, 18 are integrally joined together in the area of the overlap.

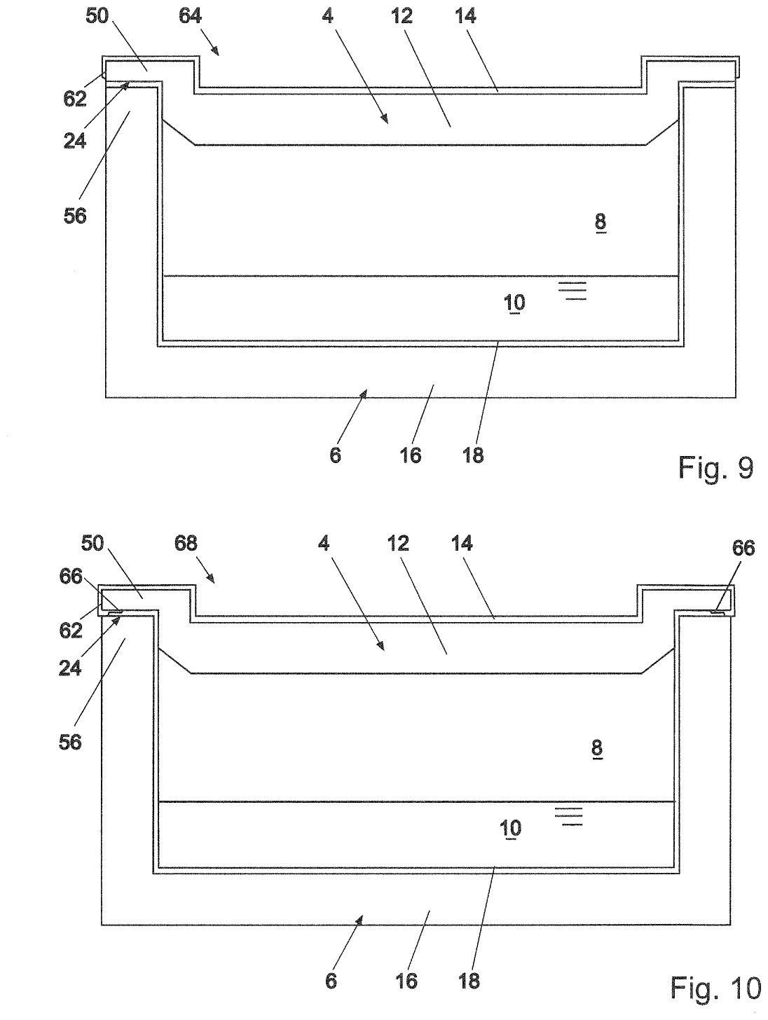

FIG. 9 shows another variant of a liquid container 64 according to the invention, in which the first half-shell 4 forms a cover of the second half-shell 6. The first barrier layer 14 is turned down on the end-face side in the area of the circumferential web 50, so that an end-face side 62 of the web 50 is at least partially covered.

FIG. 10 shows another variant of a liquid container 68 according to the invention; in contrast to the variant in FIG. 9, the barrier layers 14, 18 in the present case are integrally joined together. Thus, the first barrier layer 14 is completely turned down around the circumferential web 50; i.e., the end-face side 62 is completely covered by the barrier layer 14, so that the barrier layers 14, 18 are welded together in the area of an overlap 66.

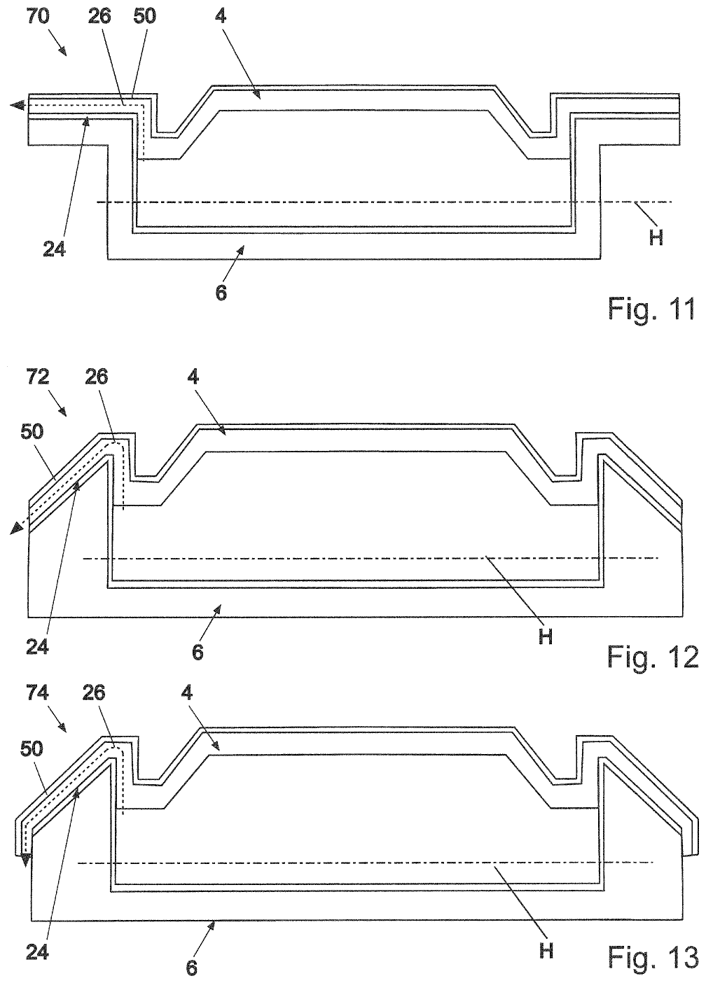

FIGS. 11 through 13 show liquid containers 70, 72, 74, respectively, and illustrate how the length of the permeation path 26 may be increased by optimizing the design of the connecting area 24 in order to limit the diffusion-related fuel emissions.

Of the three examples shown in FIGS. 11, 12, and 13, the shortest permeation path 26 results for the variant in FIG. 11, showing a liquid container 70. The permeation path 26 may be lengthened by orienting the web 50 at an angle with respect to a horizontal plane H (FIG. 12).

In order to design the web 50 with a longer extension along an outer side of the second half-shell 6, as illustrated in FIG. 13, the permeation path 26 may be extended farther in order to further limit the diffusion-related emissions.

### LIST OF REFERENCE SYMBOLS

2 liquid container/plastic fuel container
4 first half-shell
6 second half-shell
8 storage volume
10 liquid/fuel
11 first support layer
12 first barrier layer
14 second support layer
16 second barrier layer
20 side
22 side
24 connecting area
26 permeation path
28 liquid container/plastic fuel container
30 side
32 molded element
34 connecting part
36 functional unit
38 liquid container/plastic fuel container
39 side
40 local plastic molding/pedestal
42 surge tank
44 liquid container/plastic fuel container
46 first barrier layer
48 [second] barrier layer
50 web
52 liquid container/plastic fuel container
54 liquid container/plastic fuel container
56 receptacle
58 laser
60 liquid container
62 end-face side
64 liquid container
66 overlap
68 liquid container/plastic fuel container
70 liquid container/plastic fuel container
72 liquid container/plastic fuel container
74 liquid container/plastic fuel container
l length
b width
H plane

What is claimed is:

1-15. (canceled)

16. A liquid container for a motor vehicle, comprising:
a first half-shell that forms an upper shell of the liquid container; and
a second half-shell that forms a lower shell of the liquid container, wherein:
the half-shells delimit a storage volume for accommodating liquid,
the first half-shell has a first support layer and a first barrier layer,
the second half-shell has a second support layer and a second barrier layer,
the first barrier layer is externally situated on a side of the first support layer facing the storage volume, and
the second barrier layer is internally situated on a side of the second support layer facing the storage volume.

17. The liquid container according to claim 16, wherein the first support layer on a side facing the storage volume has one or more molded elements, connecting parts, or functional units.

18. The liquid container according to claim 17, wherein:
the molded elements, connecting parts, or functional units extend with protrusion into the storage volume; and/or
the molded elements and/or connecting parts have been formed in one piece with the first support layer in an injection molding process and/or sequentially molded onto the first support layer.

19. The liquid container according to claim 17, wherein all molded elements, connecting parts, or functional units situated in the storage volume are provided on the first support layer, with no molded elements, connecting parts, or functional units situated in the storage volume being provided on the second barrier layer.

20. The liquid container according to claim 16, wherein a plastic that is used for attaching molded elements, connecting parts, or functional units is locally molded onto a side of the second barrier layer facing away from the second support layer.

21. The liquid container according to claim 16, wherein:
at least one of the barrier layers is a one-ply film that has been integrally joined to the associated support layer in an injection molding process; and/or
at least one of the barrier layers is a multi-ply film that has been integrally joined to the associated support layer in an injection molding process.

22. The liquid container according to claim 16, wherein:
the half-shells in the connecting area are integrally joined together, the first support layer in the connecting area being integrally joined to the second barrier layer and/or the second support layer; and
the first barrier layer and the second barrier layer in the connecting area are spaced apart from one another and border the first support layer on both sides, wherein the first support layer in the connecting area forms a permeation path between the storage volume and the surroundings of the liquid container.

23. The liquid container according to claim 22, wherein:
a length of the permeation path, viewed in a cross section, is greater than or equal to twice the width of the permeation path; and
the width of the permeation path corresponds to the distance between the barrier layers in the connecting area.

24. The liquid container according to claim 22, wherein a length of the permeation path, viewed in a cross section, is greater than a wall thickness of the first half-shell and of the second half-shell.

25. The liquid container according to claim 16, wherein the first barrier layer and the second barrier layer are integrally joined together.

26. The liquid container according to claim 16, wherein:
the first barrier layer essentially completely covers the side of the first support layer facing away from the storage volume; and/or
the second barrier layer essentially completely covers the side of the second support layer facing the storage volume.

27. The liquid container according to claim 16, wherein:
at least one of the half-shells has a web, wherein the web is seated in a form-fit manner in a receptacle of the respective other half-shell that has a complementary shape, at least in sections; and
an integral bond of the half-shells is formed along the web.

28. The liquid container according to claim 27, wherein the barrier layer of the half-shell that has the web is turned down around the web on the end or encloses the web, the barrier layer at least partially covering an end-face side of the web.

29. The liquid container according to claim 27, wherein the web, at least in sections, is made of a laser-transparent plastic, the integral bond having been formed by laser transmission welding.

30. A method for manufacturing a liquid container, comprising the steps of:
injection molding of a first half-shell that forms an upper shell of the liquid container, the first half-shell having a first support layer and a first barrier layer;
injection molding of a second half-shell that forms a lower shell of the liquid container, the second half-shell having a second support layer and a second barrier layer; and
joining the half-shells in such a way that the half-shells delimit a storage volume for accommodating liquid, the first barrier layer being externally situated on a side of the first support layer facing away from the storage volume, and the second barrier layer being internally situated on a side of the second support layer facing the storage volume.
